(19) United States
(12) Patent Application Publication
(10) Pub. No.: US 2019/0172154 A1
(43) Pub. Date: Jun. 6, 2019

(54) Processor for real and quick payroll and tax documents

(71) Applicants: John H. Lee, Olathe, KS (US); Richard A. Lee, Olathe, KS (US)

(72) Inventors: John H. Lee, Olathe, KS (US); Richard A. Lee, Olathe, KS (US)

(21) Appl. No.: 16/025,275

(22) Filed: Jul. 2, 2018

Related U.S. Application Data
(60) Provisional application No. 62/595,044, filed on Dec. 5, 2017.

(51) Int. Cl. G06Q 40/00; G06Q 20/10

(52) U.S. Cl. CPC G06Q 40/123; G06Q 20/10

(57) ABSTRACT

The present invention provides a processor for real and quick payroll and tax documents through a computational hardware processor. Tax information and personal information are inputted through the processor. Then payroll and tax documents of tax, payroll payment, tax withholding, withholding report, and tax return are processed and displayed through the processor. Real payroll and tax documents are obtained quickly when real information is inputted or adjusted. Then the two existing tax systems for employers to estimate income taxes and for employees to collect related estimations with tax returns can be improved to reduce significant tax processing time and costs. The two existing tax systems have about 13 months apart. We have developed the processor to use a linear and gradual (LG) tax rate system with filing period factor (F) and tax status (S) numbers recently. Then all parties of employers, employees and related federal/state governments use a common tax format, which can simplify tax calculation, analysis, reform and projection and help to treat mass taxation data. The processor for real and quick payroll and tax document can help governments, employers, and employees, which may be worth billions of dollars.

### FIELD OF THE INVENTION

This present invention provides a processor for real and quick payroll and tax documents through a computational hardware processor. Tax information and personal information are inputted through the processor. Payroll and tax documents of tax, payroll payment, tax withholding, withholding report, and tax return are processed and displayed through the processor. Real payroll and tax documents are obtained quickly when real information is inputted or adjusted, which reduces tax processing time comparing with the existing tax processors or products. We have developed the processor to use a linear and gradual (LG) tax rate system with filing period factor (F) and tax status (S) numbers recently. Then all parties of employers, employees and related federal and state governments use a common tax format, which simplifies tax calculation, analysis, reform and projection and helps to treat mass taxation data. The processor for quick and real payroll and tax documents helps governments, employers, and employees, which may be worth billions of dollars.

### BACKGROUND OF THE INVENTION

Marginal tax systems with multi tax brackets are used for tax systems in the U.S. and many other countries. Existing U.S. federal and state tax systems for individuals and businesses are based on their marginal tax systems. A marginal tax rate is a percent tax rate, which is a flat tax rate, during a tax bracket. Many tax brackets are needed for smooth tax rate changes, which involve more time and costs. But less tax brackets mean unsmooth tax rate changes with a marginal tax system. For a practical purpose, several tax brackets are usually used. 2013-2017 U.S. federal personal tax systems have 7 tax brackets, which are reformed and changed from 25 tax brackets in 1970, 16 tax brackets in 1980, 5 tax brackets in 2000 and 6 tax brackets in 2012. Also an existing federal tax system has 21-page withholding tables and 12-page tax tables with changeable numbers. They are complex.

Tax systems with more tax brackets have smoother tax rate changes, but they are more complex and take more time and costs to calculate, process, analyze, modify, project, and reform. Flat tax rates are too simple, which can not cover different incomes reasonably with high tax rates to low incomes and low tax rates to high incomes. Personal income tax systems involve different tax statuses, which are more complex than business tax systems. Marginal tax systems are difficult to be reformed simply and reasonably. From the existing federal tax systems, tax fraud crimes have significant challenge, which cost the IRS some $5.2 billion in 2013.

There are two tax systems in an existing U.S. federal or state personal tax system with multi tax statuses. One tax system is Tax Rate Schedules (including related tax withholding tables for different filing periods with up to 22 pages), which are used for employers to estimate employees' income taxes. Another tax system includes Tax Table (up to 12 pages) and Tax Computation Worksheet, which are used for employees to calculate real income taxes for filling tax returns. The two tax systems, which have similar tax rates, require all employees to collect their estimated taxes and file tax returns. Table 1 shows partial Tax Rate Schedules. Table 2 shows partial withholding tables from the 21 pages. Table 3 shows partial Tax Table from the 12 pages with taxable incomes $100,000 or less. They have slight changes almost yearly such as tax rates at $100,000 from 16.7% in 2014 to 16.6% in 2015 or 16.5% in 2016 and 2017. There are about 138 million federal tax returns per year in 2013-2016 with significant tax processing time and costs.

The time difference between Tax Rate Schedules/Tax Withholding Table and Tax Table/Tax Computation Worksheet is about one year and two months apart. Such as 2016 Tax Rate Schedules with 7 tax brackets and tax rate ranges 10%-39.6% are published in November, 2015, which are used for employers to estimate employees' income taxes for 2016 withholding taxes. 2016 Tax Table and Tax Computation Worksheet are published in January, 2017 and used for employees to calculate their income taxes for filing tax returns by Apr. 15, 2017. Comparing 2017 with 2016 and 2015, their tax rate schedules, withholding tables, tax tables and, tax computation worksheets have slight changes each year even though they have the same 7 tax brackets, tax rate ranges 10%-39.6%. There are also changes for related tables and data changes over different filing periods on such as bi-weekly, monthly, quarterly or semi-yearly basis. All changes, even very slight changes, make our tax systems complex, which increase tax processing time and costs.

Based on the two federal income tax systems of early tax estimations from Tax Rate Schedules/Tax Withholding Table and later tax calculations for tax returns from Tax Table/Tax Computation Worksheet, tax processors or software products for payrolls, withholding taxes and tax returns are designed and used. For Tax Table as an example, related computer processors or products need to cover many independent tax numbers (about 10,832) in Tax Table (12 pages) with more data space. More flat tax rates have smoother tax rate changes. But they are more complex and take more time and costs for tax search, calculation, analysis, reform and projection. Many states have similar marginal tax systems. Hawaii has 12 tax brackets for its personal tax system with 3 tax statuses, which are the most complex in all U.S. states. California has 10 tax brackets (2015) or 9 tax brackets (2017) in its personal tax system. Ohio has 9, Missouri has 10, and Iowa has 9 tax brackets. They need to be simplified with smooth tax rate changes and less tax brackets.

TABLE 1
Federal Individual Tax Rate Schedules for Income Tax Estimation

| | | | |
|---|---|---|---|
| Taxable income (TI) | | | |
| Over Not over | Tax is | The Amount is over | Tax Computation |

Schedule Y 1 - Married Filing Jointly or Qualifying Widow(er)

| | | | |
|---|---|---|---|
| 0-18,450 | 10% | 0 | 0.1 * TI |
| 18,450-74,900 | $1,845 + 15% | $18,450 | 1,845 + 0.15 * (TI − 18,450) |
| 74,900-151,200 | $10,312.50 + 25% | 74,900 | 10,312.50 + 0.25 * (TI − 74,900) |
| 151,200-230,450 | * $29,387.50 + 28% | 151,200 | 29,387.50 + 0.28 * (TI − 151,200) |
| 230,450-411,500 | $51,577.50 + 33% | 230,450 | 51,577.50 + 0.33 * (TI − 230,450) |
| 411,500-464,850 | $111,324.00 + 35% | 411,500 | 111,324.00 + 0.35 * (TI − 411,500) |
| 464,850 | * $129,996.50 + 39.6% | 464,850 | 129,996.50 + 0.396 * (TI − 464,850) |

Schedule Z - Head of Household

| | | | |
|---|---|---|---|
| 0-13,150 | 10% | 0 | 0.1 * TI |
| 13,150-50,200 | $1,315.00 + 15% | $13,150 | 1,315 + 0.15 * (TI − 13,150) |
| 411,500-439,000 | $115,737 + 35% | 411,500 | 115,737 + 0.35 * (TI − 411,500) |
| 439,000 | $125,362 + 39.6% | 439,000 | 125.362 + 0.396 * (TI − 439,000) |

Schedule X - Single

| | | | |
|---|---|---|---|
| 0-9,225 | 10% | 0 | 0.1 * TI |
| 413,200 | $119,996.25 + 39.6% | 413,200 | 116,163.75 + 0.396 * (TI − 413,200) |

Schedule Y 2 - Married Filing Separately

| | | | |
|---|---|---|---|
| 0-9,225 | 10% | 0 | 0.1 * TI |
| 232,425 | $64,998.25 + 39.6% | 232,425 | 64.998.25 + 0.396 * (TI − 232,425) |

Besides many tax numbers (10,832) in the Tax Table for taxpayers to file tax returns, another complex area is tax withholding tables on different filing periods for employers to estimate withholding income taxes. Kansas has 22-page tax withholding tables with many tax numbers based on the two tax filing statuses and different filing period of weekly, bi-weekly, semi-monthly, monthly or quarterly basis, which are complex for employers to use to file KS withholding taxes. Missouri tax system is simple with the same Tax Chart for different tax filing statuses, which means there is no difference between different tax filing statuses. Missouri tax withholding tables have 10 pages, which is still complex for employers to estimate withholding income taxes. The federal IRS has complex tax withholding tables with 21 pages on the different tax filing statuses and filing period of weekly, bi-weekly, semi-monthly, monthly or quarterly basis.

TABLE 2
Partial Federal Tax Withholding Table (Monthly) for Married Persons

| | | the # of withholding allowance claimed is-- | | | | | | |
|---|---|---|---|---|---|---|---|---|
| Wage range | | 0 | 1 | 2 | 3 | . . . | 9 | 10 |
| 0 | 720 | 0 | 0 | 0 | 0 | . . . | 0 | 0 |
| 1,000 | 1,040 | 30 | 0 | 0 | 0 | . . . | 0 | 0 |
| 2,560 | 2,600 | 201 | 152 | 118 | 85 | . . . | 0 | 0 |
| 4,160 | 4,200 | 414 | 391 | 340 | 289 | . . . | 42 | 8 |
| 6,000 | 6,040 | 717 | 667 | 616 | 565 | . . . | 262 | 211 |

TABLE 3
Partial Federal Tax Table (12 pages)

| | | 2016 Tax | | | |
|---|---|---|---|---|---|
| Taxable income (TI) | | Y-1 | Z | X | Y-2 |
| 0 | 5 | 0 | 0 | 0 | 0 |
| 5 | 15 | 1 | 1 | 1 | 1 |
| 1,000 | 1,025 | 101 | 101 | 101 | 101 |
| 50,000 | 50,050 | 6,581 | 6,846 | 8,300 | 8,300 |
| 99,950 | 100,000 | 16,581 | 19,316 | 21,064 | 21,519 |

TABLE 4
Tax Computations for Married Filing Jointly

| Taxable income (TI) | | | Taxable income (TI) | | |
|---|---|---|---|---|---|
| Over | Not over | 2016 Tax | Over | Not over | 2015 Tax |
| 0 | 100,000 | Tax Table (12 pages) | 0 | 100,000 | Tax Table (12 pages) |
| 100,000 | 151,900 | 0.25*TI − 8,457.5 | 100,000 | 151,200 | 0.25*TI − 8,412.5 |
| 151,900 | 231,450 | 0.28*TI − 13,014.5 | 151,200 | 230,450 | 0.28*TI − 12,948.5 |
| 231,450 | 413,350 | 0.33*TI − 24,587 | 230,450 | 411,500 | 0.33*TI − 24,471 |
| 413,350 | 466,950 | 0.35*TI − 32,854 | 411,500 | 464,850 | 0.35*TI − 32,701 |
| 466,950 | | 0.396*TI − 54,333.7 | 464,850 | | 0.396*TI − 54,084 |

Marginal tax systems have been used in the U.S. federal and many state tax systems for individual and business tax systems. One or few flat tax rates, which are too simple, can not cover different taxable incomes reasonably. Many other countries also usually use marginal tax systems and have similar issues and challenges, which are difficult to be reformed with changing taxable income ranges, tax numbers in tax tables, computations and brackets in complex formats.

Tax processors and software products have been developed for payroll, tax withholding and tax return systems based on existing tax systems with various attempts made over the years. U.S. Pat. No. 9,911,160 discloses a method for individual income tax payment method for accurate payments. U.S. Pat. No. 9,330,415 discloses a personal savings plan for saving money through payroll withholding. U.S. Pat. No. 9,064,285 discloses a payroll service to obtain employee information from the payroll service for adding a new employee. U.S. Pat. No. 8,788,412 discloses a system and method for processing transaction and tax data, verifying tax calculations/determinations, reconciling calculation/determination errors, and filing and/or paying taxes. U.S. Pat. No. 8,694,394 is directed to a computer-based method performed in a transaction-tax-related application.

AU20160343941 discloses a tax matching and identification system, which may receive tax information, combine into a single form, and apply various software processes to calculate and compare to determine tax compliance. WO2018102200 discloses a computer-implemented method for collecting tax data for an electronic tax return preparation program. CN206684732 discloses a special calculator for economics. WO2009055665A2 discloses a system for generation of accounts payable processing system for a tax jurisdiction. CA2960788 discloses using a predictive model to determine tax topics which are relevant to a taxpayer during preparation of an electronic tax return.

U.S. Pat. No. 8,682,766 discloses a method for providing a set of automated financial services to a set of clients. The set of automated financial services include payroll processing, trust fund management, investment of funds and ACH transactions processing. U.S. Pat. No. 8,612,318 discloses a method and system for payroll tax settlement that receives payroll tax files from a payroll provider system. U.S. Pat. No. 8,165,936 discloses a payroll system and method for generating, accumulating and reporting on payroll information. U.S. Pat. No. 8,099,342 discloses the methods, apparatus, and articles of manufacture for tax computation, management, and compliance reporting via a centralized transactional tax platform. U.S. Pat. No. 8,099,329 discloses the systems and methods for determining taxes owed for financial transactions conducted over a network.

U.S. Pat. No. 8,082,144 discloses a tax calculation generator. U.S. Pat. No. 7,966,231 discloses a method and system for determining taxes attributable to a financial transaction to create a tax rate table. U.S. Pat. No. 7,610,226 provides a system for tax data collection from the tax data provider to connect electronically with a taxing authority, file the electronic tax return with the taxing authority, and arrange electronically for the payment or receipt of any tax liability or refund, respectively. U.S. Pat. No. 7,539,635 discloses a system and method for generating personalized tax device documents. U.S. Pat. No. 6,993,502 discloses a system and method for computing and collecting taxes, which has applications for determining taxes for transactions conducted over the Internet. U.S. Pat. No. 4,324,975 discloses a tax calculator for calculating Federal Income Taxes.

Besides the U.S., many other countries also use marginal tax systems with multi tax brackets for income tax systems. Multi or many tax brackets are needed for smooth tax rate changes. But more tax brackets make tax systems more complex and difficult to be operated and reformed, which need more tax processing time and costs. China has 7 tax brackets (tax rates: 3-45%) for its personal income tax system, which is shown in Table 5. Japan has 7 tax brackets (tax rates: 5-40%), which is shown in Table 6. They may be simplified with less tax brackets and compatible results.

TABLE 5
Chinese Personal Tax Rates (Monthly)

| # | Taxable income/M(TI) | Tax Rate | Tax Computation |
|---|---|---|---|
| 1 | not over 1,500 | 3% | 0.03*TI |
| 2 | 1,500-4,500 | 10% | 0.03*1500 + 0.1*(TI − 1500) = 0.1*TI − 105 |
| 3 | 55,000-80,000 | 20% | 45 + 0.1*3000 + 0.2*(TI − 4500) = 0.2*TI − 555 |
| 4 | 9,000-35,000 | 25% | 45 + 300 + 0.2*4500 + 0.25*(TI − 9000) = 0.25*TI − 1005 |
| 5 | 35,000-55,000 | 30% | 345 + 900 + 0.25*26000 + 0.3*(TI − 35000) = 0.3*TI − 2755 |
| 6 | 55,000-80,000 | 35% | 7745 + 0.3*20000 + 0.35*(TI − 55000) = 0.35*TI − 5505 |
| 7 | over 80,000 | 45% | 13745 + 0.35*25000 + 0.45*(TI − 80000) = 0.45*TI − 13505 |

TABLE 6
Existing Japanese Individual Income Tax Rates

| # | Tax Base (TB) | Tax Rate | Tax Computation |
|---|---|---|---|
| 1 | 0-1,950,000 | 5% | 0.05*TI |
| 2 | 1,950,000-3,300,000 | 10% | 0.05*1,950,000 + 0.1*(TB − 1,950,000) |
| 3 | 3,300,000-6,950,000 | 20% | 232,500 + 0.2*(TB − 3,300,000) |
| 4 | 6,950,000-9,000,000 | 23% | 23% of base exceeding of 6,950,000 |
| 5 | 9,000,000-18,000,000 | 33% | 33% of base exceeding of 9,000,000 |
| 6 | 18,000,000-40,000,000 | 40% | 40% of base exceeding of 18,000,000 |
| 7 | over 40,000,000 | 45% | 45% of base exceeding of 40,000,000 |

Germany has 4 tax brackets (tax rates: 0-45%) for its income tax system. Canada has 4 tax brackets (tax rates: 15-29%). New Zealand has 4 tax brackets (tax rates: 10.5-33%). United Kingdom 3 tax brackets (tax rates: 20-45%). Tax brackets and tax rates are often changed in national and local tax systems over time such as New Zealand had 7 tax brackets (tax rates: 15-39%) in 2008 and China had 9 tax brackets (tax rates: 5-45%) in 2007. More tax brackets mean more smooth tax rate changes, which are more reasonable for different taxable incomes. But more tax brackets involve more time and costs. Less tax brackets mean unsmooth tax rate changes with a marginal tax system.

### SUMMARY OF THE INVENTION

This invention discloses a processor for quick and real payroll and tax documents through a computational hardware processor. Tax information is inputted through its keyboard and monitor. Then payroll and tax documents of tax, payroll, tax return, tax withholding, and tax report are processed and displayed through the processor. When real tax information is provided or adjusted, real payroll and tax document are processed and obtained quickly. Personal information is inputted for identification. All parties of businesses, employees and related federal or state government the same tax system as a common tax format, which helps tax calculate, analysis, reform, and projection and treats mass tax data. The existing tax systems have the two tax formats as references, which are difficult and take long time to do tax calculations, analysis, reform, and projection. The processor for quick and real payroll and tax documents helps governments, employers and employees.

The processor is a computational hardware processor with monitor, keyboard, mouse, memory, storage and data processor. After inputting real tax information, real payroll, adjusted gross incomes (AGI), taxable income, tax rate, income tax, withholding tax, tax withholding report, and tax return are processed and obtained quickly by the tax processor. When filing period factor (F) is numbered as 1 (yearly basis), employers can do yearly withholding taxes and tax withholding reports and employees do tax returns, which can be done manually or automatically.

Tax information contains filing period factor (F), tax status (S), income, standard or itemized deduction, exemption, retirement, medical insurance, property tax, cost, interest, credit and other related tax information. Filing period factor (F) is numbered as 26, 24, 12, 52, 365, 4, 2 or 1 on bi-weekly, semi-monthly, monthly, weekly, daily, quarterly, semi-annual or annual basis. Employers may use different filing period factor (F) for calculating withholding taxes. When a person has stable bi-weekly income $2,050, its yearly income is $53,300 (2,050*26). When income is not stable, real income is usually adjusted by the end of a year. A tax status (S) is one choice from different tax statuses of Married Filing Jointly, Married Filing Separately, Qualifying Widow(er), Head of Household, and Single, which may also be numbered to such as 2 for Married Filing Jointly, 1 for Married Filing Separately, 1.5 for Head of Household, 2 for Qualifying Widow(er), 1 for Single. New filing period factor (F) and tax status numbers are developed the processor in 2017.

Personal information contains name, social security number, address, spouse, child, dependent, and other related personal information, which is used for identification. For security purpose, a password may be used. Tax fraud crimes cost governments and taxpayers billions of dollars per year. Existing two tax systems for estimations and tax returns have about one year delay or apart. Many tax returns are needed to be processed during the busy tax season and tax refunds are usually issued without difference comparisons because of time limitation, which may cause potential tax fraud crimes.

A payroll processor is a computational hardware processor and contains employee information setup, working time entry, earning, company information setup, payroll processing, result output, paycheck generation, payroll tax deposit, information adjustment, final payroll output, and payroll report. Payroll is to process and deduct social security tax, Medicare, federal and state income taxes, retirement, medical insurance, and deductions from income or wage, and add credits. Income tax is the most changeable and complex item during all deductions and additions. Other deductions and additions from income or wage are simple percents and constant numbers. Income tax is the important and complex item for payroll calculation and process. In this patent application, the filing period factor (F) and tax status (S) are two important numbers for tax and payroll simplifications. When real employee information is inputted, quick and real payroll results are processed and outputted. Real employee information can be adjusted by the end or early next year (January) when real employee information cannot be provided during a year. The payroll processor has its function to adjust real payroll information. Tax is a key factor in payroll and tax documents.

A tax return is an important tax document. Tax return processor is a computational hardware processor and contains employee information entry by inputting related tax information and personal information, data processing, tax rate and tax outputs, and final tax balance (own or due) output. Income tax and tax status are two important items for tax balance calculation and tax return process. Tax information includes at least income, tax status, reduction, exemption, retirement, credit, and withholding tax. Then adjustable gross incomes (AGI), taxable income, tax rate, and tax are processed and outputted. Basic personal information contains name, social security number, address, child, bank account for refund, and employer information. Tax returns with non-complex situations and standard deductions may be replaced by tax withholding reports, which are from an employer, with or without modification when people have standard deductions and non-complex tax situations such as taxable incomes less than $100,000. Then these taxpayers such as 30-60% of tax returns may have option to not file tax returns for reducing significant time and costs. Also minor tax refunds such as less than $200 tax refunds for federal tax returns or less than $100 tax refunds for state tax returns may be relayed to next year to save processing tax refund time and costs. Employee information may be provided by an employer through tax withholding reports.

It is reported there are about 138 million federal taxpayers in the U.S. with reported earnings of $9.03 trillion in AGI and paid $1.23 trillion in income taxes in 2013. The top 50% of all taxpayers paid about 97.2% of all income taxes. The bottom 50% paid the remaining 2.8% with an average income tax $499. During the 138 million federal tax returns, 90% of the tax returns have AGI less than $127,695 and 75% of the tax returns have AGI less than $74,955.

Existing Tax Rate Schedules and Tax Withholding Tables are used for employers to estimate income taxes and then existing Tax Table and Tax Computation Worksheet are used for employees to calculate real income taxes for tax returns, which require every employee to collect prior estimation and file tax return. We have developed the linear and gradual (LG) tax rate system with filing period factor (F) to combine the Tax Rate Schedules, Tax Withholding Table, Tax Table and Tax Computation Worksheet together simply, which is shown in Table 7. Common filing period factor (F) of 26, 24, 12, or 1 on bi-weekly, semi-monthly, monthly or annual basis is used by employers and employees to calculate taxes. After reducing existing 7 tax brackets to 4, tax rate differences between existing and LG tax systems are compatible, which are shown in Table 8.

Tax status (S) contains such as Married Filing Jointly, Qualifying Widow(er), Head of Household, Single or Married Filing Separately. We have developed a tax status (S) number to 2 for Married Filing Jointly, 1 for Married Filing Separately, 1 for Single, 1.5 for Head of Household, and 2 for Qualifying Widow(er) within 0.5-2 range or another range. Another new tax status may be formed in the future. For many states, which include such as California (10 tax brackets), Hawaii (12 tax brackets), Missouri (10 tax brackets), and Kansas, tax status (S) number is 1 for Single, 2 for Qualifying Widow(er) or ˜1.5 is for Head of Household. Table 9 shows tax simplifications for California to combine its tax schedules, withholding table, tax table and tax computation together simply. We have developed a simple tax rate formula of a+TI*F/(b*S) or c−d*S/(TI*F) (TI is taxable income and a, b, c and d are constants) with F and S numbers for calculating tax rate and income tax in 2017. Linear tax rates are the most reasonable and smooth tax rate changes. Existing 10 tax brackets in California are reduced to 3 or 2 with 70-80% reduction. Tax rate differences between its existing and LG tax systems are compatible each other.

TABLE 7
LG Tax Rate System for Federal Individual Tax Return
(1) Married Filing Jointly or widow(er) (MFJ), (2) Head of Household,
(HH) (3) Single (S), and (4) Married Filing Separately (MFS)

| Filing | Taxable Income (TI) | | | | Tax | Range | Tax |
|---|---|---|---|---|---|---|---|
| Status | Over | Not over | Your TI | LG tax rate formula | rate | check | TI * rate |

| | | | | |
|---|---|---|---|---|
| 11 | 0 | 100,000 | 0.1 + TI * F/1,515,151.5 | 0.1-0.166 |
| 12 | 100,000 | 250,000 | 0.122 + TI * F/2,272,727.3 | 0.166-0.232 |
| 13 | 250,000 | 450,000 | 0.176 + TI * F/4,444,444.4 | 0.232-0.277 |
| 14 | 450000 | | 0.396-53,550/TI * F | 0.277-0.396 |
| 21 | 0 | 100,000 | 0.1 + TI * F/1,075,269 | 0.1-0.193 |
| 22 | 100,000 | 250,000 | 0.155 + TI/2,631,579 | 0.193-0.250 |
| 23 | 250,000 | 450,000 | 0.2025 + TI/5,263,158 | 0.250-0.288 |
| 24 | 450000 | | 0.396-48,600/TI * F | 0.288-0.396 |
| 31 | 0 | 75,000 | 0.1 + TI * F/797,872.3 | 0.1-0.194 |
| 32 | 75,000 | 200,000 | 0.1616 + TI * F/2,314,815 | 0.194-0.248 |
| 33 | 200,000 | 400,000 | 0.207 + TI * F/4,878,049 | 0.248-0.289 |
| 34 | 400000 | | 0.396-42,800/TI * F | 0.289-0.396 |
| 41 | 0 | 50,000 | 0.1 + TI * F/757,575.8 | 0.1-0.166 |
| 42 | 50,000 | 125,000 | 0.122 + TI/1,136,363.6 | 0.166-0.232 |
| 43 | 125,000 | 225,000 | 0.176 + TI/2,222,222.2 | 0.232-0.277 |
| 44 | 225,000 | | 0.396-26,775/TI | 0.277-0.396 |

TABLE 8
Comparison between existing federal and LG tax rates
for Married Joint (After reducing 7 taxable income
ranges to 4 and simplifying taxable income ranges)

| Taxable income | Existing tax rates | LG tax rates | Tax rate difference |
|---|---|---|---|
| 50.1 | 12.00% | 10.0% | −2.00% |
| 1,001 | 10.1% | 10.1% | 0.0% |
| 20,000 | 10.4% | 11.3% | 0.9% |
| 70,000 | 13.7% | 14.6% | 0.9% |
| 100,000 | 16.6% | 16.6% | 0.0% |
| 200,000 | 21.6% | 21.0% | 0.6% |
| 400,000 | 26.9% | 27.0% | 0.1% |
| 1,000,000 | 34.2% | 34.3% | −0.1% |
| 5,000,000 | 38.5% | 38.5% | 0.0% |
| 10,000,000 | 39.3% | 39.3% | 0.0% |

TABLE 9
LG Tax Rate System for California Individual Tax Return (3 tax brackets)

| | | | | | | |
|---|---|---|---|---|---|---|
| | Yearly TI/S | | | Tax | | Tax |
| TI * F/S | Over Not over | TI | LG tax rate formula | rate | Range check | TI * rate |

| | | |
|---|---|---|
| 0/100,000 | 0.011 + TI * F/(1,562,500 * S) | 0.011-0.075 |
| 100,000/500,000 | 0.0672 + TI * F/(12,820,513 * S) | 0.075-0.1062 |
| 500000 | 0.1463 + 20,050 * S/(TI * F) | 0.1062-0.1463 |

Total Tax (S=1)=0.011ΣTI1+ΣTI1/1,562,500+0.0672Σ(TI2)²+ΣTI2/12,820,513+0.1463ΣTI3−20,050 n

When a federal tax system with tax status (S) number is designed to 1 for Married Filing Separately or Single, 2 for Married Filing Jointly/Qualifying Widow(er) or 1.5 for Head of Household, tax simplification is shown by Table 10 (2017), which can be used by all related parties simply. Existing 7 tax brackets are reduced to 3 with 57% reduction compatibly. Then for mass tax data from many employees or businesses, tax analysis and projection for total tax become more practical to be done. For about 138 million federal tax returns in the U.S., the top 50% of all taxpayers paid about 97.2% of all income taxes and the bottom 50% paid the remaining 2.8%. When a tax reform is proposed, related taxable income and tax rate ranges and tax brackets as technical factors instead of “complex” political factors are reformed to match its tax revenue goal. Also federal and state tax return systems may be combined together for their simplification purpose.

TABLE 10
LG Tax Rate System for Federal Individual Tax Return (3 tax brackets)

| | | | | | | |
|---|---|---|---|---|---|---|
| | Yearly TI/S | | | Tax | Range | Tax |
| TI * F/S | Over Not over | TI | LG tax rate formula | rate | check | TI * rate |

| | | |
|---|---|---|
| 0/50,000 | 0.01 + TI * F/(769,230.8 * S) | 0.01-0.165 |
| 50,000/250,000 | 0.1343 + TI * F/(1,626,016.3 * S) | 0.165-0.288 |
| 250000 | 0.396-27,000 * S/(TI * F) | 0.288-0.396 |

Total Tax (S=2)=0.1ΣTI1+Σ(TI1)²/1,538,461.6+0.1343ΣTI2+Σ(TI2)²/3,252,032.6+0.396ΣTI3−54,000 n

A tax withholding processor is a computational hardware processor to process withholding taxes and withholding reports. Company information, employee personal information and tax information are inputted. Federal withholding tax contains federal income, social security, and Medicare taxes, which are transferred to federal government. State withholding tax contains state income tax, which is transferred to a state government. Common filing period factor (F) of 26, 24 or 12 on bi-weekly, semi-monthly or monthly basis is used by employers. When tax information of income, working time, wage rate, social security rate at 6.2%, Medicare rate at 1.45%, tax status or status number, reduction, exemptions, retirement, child, and credit are inputted, adjusted gross incomes (AGI), taxable income, tax rate, tax and withholding tax for a filing period factor on federal and state levels are processed and outputted by the tax withholding processor. When real tax information is inputted, quick and real withholding tax results are processed and outputted. Real tax information can also be adjusted by the end or early next January of a year when real tax information is available. IRA retirement, bonus, interest, and capital gain can be added by an employee or employer to adjust to real tax information for real income tax and withholding tax. Income change and tax information can be also adjusted by employee to modify during filing a tax return.

A withholding report, which is one of tax documents, is another part of tax withholding processor. It is an output summary of tax results, company, personal, and tax information on yearly basis. When real tax information is inputted, quick and real withholding reports are processed and outputted. Real tax information can be adjusted by the end or early next year (January) when real tax information is available for yearly tax withholding reports. Detail tax results are income to tax return, social security income, social security tax, Medicare tax, tax status, standard reduction, exemption, child number, retirement, credit, income tax rate, income tax withholding, and payroll, which are provided by an employer, on federal and state levels. A tax withholding report can be used for replacing a tax return for all necessary tax result information with or without modification.

The payroll processor, tax return processor and tax withholding processor may be designed and used separately or combined together as a combination processor. Employers usually prefer to use a software product or processor to do payroll, tax withholding, and tax withholding report together.

When tax withholding reports are used by many people, who have low incomes, one-source incomes, or non-complex tax situations with standard deductions, they may use tax withholding reports to replace their tax returns with or without modification. Then they have option to not file normal tax returns. Many people use standard deductions such as 80% of tax returns in Kansas use KS standard deductions. There are about 138 million federal tax returns. Each estimated cost to average taxpayer burden is $210. If 30% tax return numbers (30%*138=41.4 millions) are reduced, then $6.2 billion (41.4*150) can be saved if at $150/each.

Employers may do tax calculations, payrolls, withholding taxes, and tax withholding reports for employees manually or automatically. Small businesses may prefer to do manual setup with a common software product such as Excel or Spreadsheet for cost reduction. Standard deduction such as $6,300 for Single or Married Filing Separately may be divided to 26 (for bi-weekly basis) with $242.31 (6300/26) or 24 (semi-monthly basis) with $262.5 (6300/24) to calculate withholding taxes on bi-weekly or semi-monthly basis. Besides reduction, exemptions and credit can also be divided from annual basis into bi-weekly, semi-monthly or monthly basis.

Many U.S. states have similar marginal tax systems with two tax systems for companies and employees differently, which need all employees even with low incomes and simple tax situations to file tax returns. Smooth tax rates require multi tax brackets. Taxes are calculated by the progressive method with more procedures and complex computational hardware processors or products. Their situations can be simplified similarly as federal tax systems such as to simplify existing 10 tax brackets in Missouri to 2 with 80% reduction, 9 tax brackets in IA to 2 or 3, and existing 12 tax brackets in HI to 2 with 83% reduction.

Tax withholding reports with all necessary tax results can be used as simple tax returns with or without modification, which can reduce tax return numbers to be processed to reduce tax processing time and costs significantly for governments and employees. Also tax withholding reports can be used for governments to compare with tax returns for reducing potential tax mistakes and tax crimes before sending out tax refunds. Similar tax processor can be designed for federal and state tax documents of state tax returns, withholding taxes, and tax withholding reports for individuals and businesses. With the common format with LG tax rate system, all parties of companies, employees and federal and state governments can use the same tax system as one reference. A network or web may be involved. Mass tax data from many employees or businesses, tax analysis and projection for total tax become more practical to be processed simply. Related network or web may be built up according their situations.

Business income tax systems are similar as individual tax systems. The existing federal tax rate schedule for corporations has 8 tax brackets, which may be reduced to 4, 3 or 2. Alaska has 10 tax brackets, which is shown in Table 11, is the most complex in the U.S. state tax systems. The 10 tax brackets for Alaska corporations are from 1% to 9.4% in increments of $10,000 of taxable income. When the LG tax system is used, its 10 tax brackets can be reduced to 2 with 80% reduction. Their tax rate differences between Tables 11 and 12 are very compatible. All businesses may be considered as one tax status (S=1) or more than one with different tax statuses such as S=1 for retails, S=1.5 for manufacturers or S=0.7 for consulting services within 0.5-2 range or another range.

Then TI*F in Table 12 can be reformed to TI*F/S.

TABLE 11
Existing Alaska Corporate Tax Rates (10 tax brackets)

| | |
|---|---|
| Taxable income (TI) | Tax Computations |

| | | |
|---|---|---|
| 0 | 10,000 | 0.01*TI |
| 10,000 | 20,000 | 100 + 0.02*(TI − 10,000) |
| 20,000 | 30,000 | 300 + 0.03*(TI − 20,000) |
| 30,000 | 40,000 | 600 + 0.04*(TI − 30,000) |
| 40,000 | 50,000 | 1,000 + 0.05*(TI − 40,000) |
| 50,000 | 60,000 | 1,500 + 0.06*(TI − 50,000) |
| 60,000 | 70,000 | 2,100 + 0.07*(TI − 60,000) |
| 70,000 | 80,000 | 2,800 + 0.08*(TI − 70,000) |
| 80,000 | 90,000 | 3,600 + 0.09*(TI − 80,000) |
| 90,000 | | 4,500 + 0.094*(TI − 90,000) |

TABLE 12
LG tax system for Alaska corporate tax (2 tax brackets)

| | Yearly TI/S | | | | Tax | | Tax |
|---|---|---|---|---|---|---|---|
| TI * F | Over | Not over | TI | LG tax rate formula | rate | Range check | TI * rate |

| | | | |
|---|---|---|---|
| 0 | 100,000 | 0.01 + TI * F/2,252,252.2 | 0.01-0.0544 |
| 100000 | | 0.094-3,960/(TI * F) | 0.0544-0.094 |

For tax analysis, projection, reform, and budget balance, total tax projection may be done:

Total Tax=0.01ΣTIf+Σ(TI)²f/2,252,252.2+0.094ΣTIg−3,960*g

Here f and g are corporate numbers during the two taxable income ranges. Total tax can be calculated from TI and TI² as a function of TI and TI². Then tax calculation, analysis, modification, projection, and reform can be done practically by Alaska government. Similar tax processor(s) for withholding taxes, tax withholding reports, and tax returns can be designed for state and federal business tax systems.

Many other countries can also design related computational hardware processor for quick and real payroll and tax documents. The processor uses a linear and gradual (LG) tax rate system with filing period factor (F) and tax status (S) numbers in this application. Then all parties of employers, employees and related national or local government use a common tax format, which simplifies tax calculate, analysis, reform, and projection and helps to treats mass taxation data, which simplify existing tax systems.

China has 7 individual tax brackets with tax rates 3-45% currently (Table 5), which are reformed from 9 tax brackets and tax rates of 5-45% (2007). The 7 tax brackets of 3%, 10%, 20%, 25%, 30%, 35%, and 45% can be reduced to 4 with 43% reduction. Table 13 shows the LG tax system for Chinese individuals and employers to calculate income taxes. Table 14 shows their tax rate results and differences compatibly. The current filing period factor is on monthly basis for calculating income taxes. The existing tax system is monthly (M) based and has no tax filing status difference. Standard deduction is 3,500/Month. Tax status (S) is 1 for all tax statuses, which means there is no difference for different tax statuses such as between Married Filing Jointly and Single. Also there is no personal exemption.

TABLE 13
LG Tax Rate System for Chinese Personal Tax Rates (Monthly)

| Monthly TI | Taxable income | | Tax | Range | Tax |
|---|---|---|---|---|---|
| Over Not over | (TI) | LG tax rate formula | rate | check | TI*rate |
| 0-10,000 | | 0.03 + TI/83,333.3 | | 0.03-0.15 | |
| 10,000-50,000 | | 0.12625 + TI/421,052.6 | | 0.15-0.245 | |
| 50,000-100,000 | | 0.175 + TI/714,285.7 | | 0.245-0.315 | |
| 100000 | | 0.45 − 13,500/TI | | 0.315-0.45 | |

Total Tax=0.03ΣTIm+Σ(TI2)m/83,333+0.12625ΣTIn+Σ(TI2)n/421,052+0.175ΣTIo+Σ(TI2)o/714,285.7+0.45ΣTIp−13,500 p

The 4 tax brackets may be further simplified to 3 with 57% reduction practically. For tax return purpose, its monthly basis needs to be converted into yearly basis. Table 15 shows the LG tax system on yearly basis with filing period factor of 24, 12, 4 or 1 on semi-monthly, monthly, quarterly or yearly by employers to do withholding taxes or employees to do tax returns. For yearly basis, taxable income (TI) over tax status (S) and tax rate formula can be converted into yearly basis. Tax status (S) may be designed to 1 for Married Filing Separately or Single, 1.5-2 for Married Filing Jointly/Qualifying Widow(er) within 0.5-2 range reasonably and practically. The LG tax rate formulas of a+TI*F/(S*b) and c−d*S/(TI*F) are used. A related computational hardware processor is designed for quick and real payroll and tax documents reasonably.

The existing 7 tax brackets with tax rates 5-45% (Table 6) in Japan can be simplified to 4 with 43% reduction by the LG tax system, which is shown by Table 16. Related computational hardware processor can be designed for quick and real payroll payments, withholding taxes, tax withholding reports, and tax returns. Many other countries have similar tax system situations.

TABLE 14
Comparison of Tax Rates (Existing and LG tax systems)

| Taxable income | Existing Tax System (Table 5) | | LG Tax System | |
|---|---|---|---|---|
| (TI) | Tax | Tax rate | Tax rate | Difference |
| 500 | 150 | 3% | 3.6% | 0.6% |
| 5,500 | 545 | 9.9% | 9.6% | −0.3% |
| 8,000 | 1,045 | 13.1% | 12.6% | −0.5% |
| 10,000 | 1,449 | 15.0% | 15.0% | 0.0% |
| 50,000 | 12,245 | 25.0% | 25.0% | 0.0% |
| 60,000 | 15,498 | 25.8% | 25.9% | 0.1% |
| 100,000 | 31,500 | 31.5% | 31.5% | 0.0% |
| 500,000 | 211,500 | 42.3% | 42.3% | 0.0% |
| 750,000 | 324,000 | 43.2% | 43.2% | 0.0% |
| 1,000,000 | 436,500 | 43.65% | 43.65% | 0.0% |
| 10,000,000 | 4,486,000 | 44.86% | 44.86% | 0.0% |

TABLE 15
LG Tax Rate System for Chinese Personal Tax Rates (Yearly) (3 tax brackets)

| | Yearly TI/S | | | | Tax | Range | Tax |
|---|---|---|---|---|---|---|---|
| TI * F/S | Over | Not over | TI | LG tax rate formula | rate | check | TI * rate |
| | 0 | 120,000 | | 0.03 + TI * F/(1,000,000 * S) | | 0.03-0.15 | |
| | 50,000 | 1,000,000 | | 0.13118 + TI * F/(6,376,812 * S) | | 0.15-0.288 | |
| | 1000000 | | | 0.45-162,000 * S/(TI * F) | | 0.288-0.396 | |

TABLE 16
LG Tax Rate System for Japanese Personal Tax Rates

| | | | | | |
|---|---|---|---|---|---|
| Yearly TB/S | | | Tax | Range | Tax |
| Over Not over | Tax Base | LG tax rate formula | rate | check | TI*rate |

| | | | |
|---|---|---|---|
| 0-10 | million | 0.05 + TB*F/(S*73,529,412) | 0.05-0.186 |
| 10-20 | million | 0.107 + TB*F/(S*126,582,278.5) | 0.186-0.265 |
| 20-40 | million | 0.197 + TB*F/(S*294,117,647) | 0.265-0.333 |
| 40 | million | 0.45 − 4,680,000*S/(TB*F) | 0.333-0.45 |

Total Tax=0.05ΣTIm+Σ(TI2)m/73,529+0.107ΣTIn+Σ(TI2)n/126,582,278.5+0.197ΣTIo+Σ(TI2)o/294,117,647+0.45ΣTIp−4,680,000 p

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

A man and his family with two children live in California. Their tax status is picked up from the list of Married Filing Jointly, Qualifying Widow(er), Married Filing Separately, Single or Head of Household. His annual salary is $102,345.67 from his employer. His wife is a homemaker to take care their two children, who have $1,000 tax credit for each. His retirement is at $146.15/bi-weeks and medical insurance at $153.85/bi-weeks. After inputting Married Filing Jointly, F=26 for bi-weekly basis, exemption number 4 and child tax credit $1,000*2, his initial federal income tax rate of 14.53% and bi-weekly income tax of $389.86 are shown automatically. His total bi-weekly withholding taxes including social security, Medicare, and income taxes of $614.07 are shown. His initial California income tax rate of 6.39% and bi-weekly income tax of $169.65 are shown automatically. His bi-weekly payroll payment of $2,998.80 is shown. $915.21 is shown and then transferred from his employer to the federal Internal Revenue Service and $169.65 is shown and then transferred from the employee to the state of California. Social security rate, Medicare rate, standard deduction, tax statues, filing period factor, exemption, and credit are already programmed into the computational hardware processor.

He receives a bonus of $1,200 in December, which is inputted and adjusted by the processor. Then his last (26-th) bi-weekly payroll payment of $3,763.40 is shown. His yearly federal tax rate of 14.61%, which is slightly higher than initial 14.53%, and yearly state tax rate of 6.45%, which is slightly higher than initial state tax rate of 6.39%, are shown. His income tax rates are increased because of the bonus of $1,200. His federal taxable income of $70,945.77 is shown. His yearly federal income tax of $10,366.22 and state income tax of $4,524.71 are shown. His yearly total payroll is $78,733.40. The computer processor also shows the total withholding taxes including his yearly income taxes and social security and Medicare taxes from both employee and employer are $24,208.71, which needs to be transferred to the Internal Revenue Service. His total state withholding income of $4,524.71 is shown to be transferred to his state.

The IRS and state governments may receive his yearly tax withholding report with related tax data from his employer by January 31 or February 15, which is shown in Table 17. When John Smith has his bank interest ($234.56), the number may be filled in or inputted for federal and state modifications with his tax withholding report. His federal tax will be increased by $45.13 and CA state tax be increased by $27.71. Other similar modifications can be done through his tax withholding report provided from his employer. According to the IRS report in Form 1041 Instruction, the estimated average taxpayer burden for Form 1040 is about $210.

TABLE 17
Federal and State Tax Withholding Report
From: ABC Company, 54 B Street, San Francisco, CA 98765 To: 123 A Street, San Francisco, CA 98765

| | John Smith | | | |
|---|---|---|---|---|
| | Social security # | 123456789 | Employer ID # | 987654321 |
| | Fedreal tax data | Modification* | State/California | Modification* |
| Wage/income to tax return | $99,745.77 | $99,745.77 | $99,745.77 | $99,745.77 |
| Social security wage/income | $103,545.67 | same | $103,545.67 | same |
| Other income/interest/gain | 0 | $234.56 | 0 | $234.56 |
| Other deduction | 0 | 0 | 0 | 0 |
| Adjusted gross income | | $99,980.33 | | $99,980.33 |
| Tax status (S) number | 2 | 2 | 2 | 2 |
| Standard/itemized deduction | standard | standard | standard | standard |
| Exemption number | 4 | 4 | 4 | 4 |
| Taxable income | $70,945.77 | $71,180.33 | $83,567.55 | $83,802.11 |
| Income tax formula | 0.1 + TI/1538461.5 | same | 0.011 + TI/1562500 | same |
| Income tax rate | 14.61% | 14.63% | 6.45% | 6.46% |
| Income tax | $10,366.22 | $10,411.35 | $4,524.71 | $4,552.42 |
| Child credit | 2*1000 | same | | |
| Other credits | 0 | 0 | | |
| Other tax | 0 | 0 | | |
| Tax withheld (W-2/1099) | $8,366.22 | | $4,524.71 | |
| (+)Tax payment/(−)Refund* | 0 | $45.13 | | $27.71 |
| 401K retirement | $3,799.90 | Social security | $6,419.83 | |
| Yearly payroll payment | $78,733.40 | Medicare | $1,501.41 | |

*Please attach detail information for your data modification. For a refund less than $200 for the federal or $100 for state tax return, please delay it to next year (credit) for reducing processing time and costs.

When tax returns meet certain qualifications such as standard deduction and taxable income less than $100,000, these people have option to not file normal tax returns by tax withholding reports with or without modification, which are shown in Table 17, for quick tax returns to reduce tax processing time and costs for employees and governments. Tax data from tax withholding reports can be used by the federal and state governments to compare for review or inspection purpose with tax returns, which can reduce tax mistakes and potential tax fraud crimes.

### EXAMPLE 2

A woman has the filing status of Head of Household with one young child, who live and work in Kansas with one-source income. Her tax withholding report shows her wage to tax return ($76,543.21), federal taxable income ($59,143.21), federal child tax credit ($1,000) and Kansas taxable income ($66,543.21). Her federal income tax withholding is $8,174.38 (tax rate at 15.51%) and state income tax withholding is $2,775.99 (tax rate at 4.17%). She also receives bank interest is $1,000 and makes her IRA retirement $1,500. A federal tax return processor is used to input her tax information, process and show her federal taxable income ($58,643.21), standard deduction ($9,300), exemption ($4,050*2), tax rate (15.47%), which is slight lower than 15.51%, income tax ($8,069.49), and federal income tax refund ($104.89). A Kansas tax return processor is used to input her tax information, process and show her Kansas taxable income ($66,043.21), standard deduction ($5,500), exemption ($2,250*2), tax rate (4.17%), which is the almost same as 4.17%, income tax ($2,752.99), and state income tax refund ($23.00).

When a tax refund is small such as less than such as $200 (almost equal to $210 of the average taxpayer burden for Form 1040) or $100 for federal or state tax returns, the tax refund may be delayed to next year as a credit to reduce tax processing time and cost. Her federal tax refund is $104.89 and state tax refund is $23.00 only, which can be delayed to next year for saving tax processing time and cost for the governments.

For tax returns with standard deduction and taxable income less than $100,000, tax withholding reports, which are provided by employers, may be used to replace tax returns with or without modification. Those people may have the option to not file normal tax returns when they meet certain qualifications of the federal and state governments. Also a tax refund with less than such as $200 (federal) or $100 (state) may be delayed to next year as a credit, which can reduce tax processing time and costs. Then significant tax returns numbers could be reduced for saving time and costs from this option for governments, companies and individuals.

### EXAMPLE 3

A single man works and lives in Kansas. His tax status is picked up from the list of Married Filing Jointly, Qualifying Widow(er), Married Filing Separately, Single or Head of Household. His hourly wage is $35/hour from his employer. His retirement is at $100/bi-weeks. His first two-weekly working time is 82.18 hours. After inputting Single, F=26 for bi-weekly basis, exemption number 1, his initial federal income tax rate of 17.75%, bi-weekly income tax of $422.13, and payroll payment of $2,028and are shown automatically. The total bi-weekly withholding taxes including social security and Medicare from both employee and employer, and his income taxes of $862.20 are shown. His initial Kansas income tax rate of 4.17% and bi-weekly income tax of $106.13 are shown automatically. $862.20 needs to be transferred to the federal Internal Revenue Service and $106.13 needs to be transferred to the state of Kansas. Social security tax rate, Medicare tax rate, standard deduction, tax statues, filing period factor, exemption, and credit are already are programmed into the computational hardware processor.

He receives his yearly income $75,255.00 including a bonus of $2,000. His yearly federal tax rate of 17.81%, which is slightly higher than initial 17.75%, and yearly state tax rate of 4.17%, which is almost the same as his initial state tax rate of 4.17%, are shown. His federal adjusted gross income of $72,655.00 and state taxable income of $62,305.00 are shown. His yearly federal income tax $11,095.83 and state income tax $2,781.13 are shown. His yearly total payroll is $53,021.03. The computer processor also shows the total withholding taxes including all yearly income taxes and social security and Medicare taxes from both employee and employer are $22,609.85, which needs to be transferred to the Internal Revenue Service, and the total state withholding income $2,781.13 needs to be transferred to his state.

The IRS and state governments may receive his yearly tax withholding report with his tax data from his employer by January 31 or February 15, which is shown in Table 18. Tax withholding reports may be linked to his information and tax data results automatically. Some modifications with minor changes may be filed to the IRS and KS state. When the federal and state governments receive his tax withholding report and tax return, the above tax data can be compared for review or inspection purpose.

When he has his bank interest ($2,300) and individual IRA $2,000, the number may be inputted for modification, which is shown in Table 18. His federal tax will be increased by $76.97 and KS state tax be increased by $13.80 only. Some similar modifications can be done through his tax withholding report from his employer. Federal and state governments may offer taxpayers, who meet certain qualifications, have the option to not file tax returns to reduce tax processing time and costs.

TABLE 18
Federal and State Tax Withholding Report
From: XY Tech, 34567 B Street, Olathe, KS 66051 To: 87654 A Street, Lenexa, KS 66215

| | Peter Johnson | | | |
|---|---|---|---|---|
| | Social security # | 234567891 | Employer ID # | 765432198 |
| | Fedreal tax data | Modification* | State/California | Modification* |
| Wage/income to tax return | $72,655.00 | $72,655.00 | $72,655.00 | $72,655.00 |
| Social security wage/income | $75,255.00 | same | $75,255.00 | same |
| Other income/interest/gain | 0 | $2,300.00 | 0 | $2,300.00 |
| Other deduction | 0 | $2,000.00/IRA | 0 | $2,000.00/IRA |
| Adjusted gross income | | $72,955.00 | $72,655.00 | $72,955.00 |
| Tax status (S) number | 1 | 1 | 1 | 1 |
| Standard/itemized deduction | standard | standard | standard | standard |
| Exemption number | 1 | 1 | 1 | 1 |
| Taxable income | $62,305.00 | $62,605.00 | $66,655.00 | $66,955.00 |
| Income tax formula | 0.1 + TI/797872.3 | same | 0.046-285/TI | same |
| Income tax rate | 17.81% | 17.85% | 4.17% | 4.17% |
| Income tax | $11,095.83 | $11,172.80 | $2,781.13 | $2,794.93 |
| Child credit number | 0 | | | |
| Other credits | 0 | | | |
| Other tax | 0 | | | |
| Tax withheld (W-2/1099) | $11,095.83 | | $2,781.13 | |
| (+)Tax payment/(−)Refund* | 0 | $76.97 | | $13.80 |
| 401K retirement | $2,600.00 | Social security | $4,665.81 | |
| Yearly payroll payment | $78,733.40 | Medicare | $1,091.20 | |

*Please attach detail information for your data modification. For a refund less than $200 for the federal or $100 for state tax return, please delay it to next year (credit) for reducing processing time and costs.

What is claimed is:

1. A processor for real and quick payroll and tax documents through a computational hardware processor comprising
receiving, using said computational hardware processor, at least a filing period factor (F), tax status (S), income, deductions, and credits of an employee;
using said filing period (F), tax status (S), income, deductions, exemptions, and credits to determine, via said computational hardware, an adjusted gross income and a taxable income (TI) of said employee;
using said computational hardware processor to apply said taxable income with one of linear and gradual tax rate procedures with said tax status (S) and filing period (F) to determine a tax rate and a tax for said employee;
using said computational hardware processor to automatically select a taxable income range for said employee based on related taxable income and filing tax status, said taxable income range being selected from a group of taxable income ranges, consisting of two to five taxable income ranges;
using said computational hardware processor to apply said tax to determine a payroll payment for said employee;
transferring said payroll payment from an employer to said employee;
using said computational hardware processor to apply said tax to determine a tax document of withholding tax for said employee;
transferring said withholding tax from said employer to a government;
receiving, using said computational hardware processor, real income, tax status (S) deduction, and credit of said employee when real tax information is inputted or adjusted when real tax information is available;
using said computational hardware processor to apply said tax to determine a tax document of tax withholding report on yearly basis for said employee;
transferring said tax withholding report from said employer to said government and said employee;
using said computational hardware processor to apply said tax to determine a tax document of tax return on yearly basis report by said employee;
displaying said payroll payment on an output;
displaying said individual tax document of withholding tax on an output;
displaying said individual tax document of tax withholding report on an output;
displaying said individual tax document of tax return on an output;
wherein:
application of said linear procedure by said computational hardware processor includes a+TI*F/(b*S), where a and b are constants;
application of said gradual procedure by said computational hardware processor includes c−d*S/(TI*F), where c and d are constants;
application of said filing period factor (F) by said computational hardware processor is numbered with 52, 26, 24, 12, 4, 2 or 1 on weekly, bi-weekly, semi-monthly, monthly, quarterly, semi-annual or annual basis; and
application of said tax status (S) by said computational hardware processor is numbered at between 0.5 and 2.

2. The processor for real and quick payroll and tax documents of claim 1 where the processor contains monitor, keyboard, mouse, memory, data processor, storage, and output.

3. The processor for real and quick payroll and tax documents of claim 1 where said tax status is numbered at a range of 0.5-2 with a common number 1 for Married Filing Separately, 2 for Married Filing Jointly, 0.8-1.2 for Single, 1.3-1.8 for Head of Household or 1.5-2 for Qualifying Widow(er) through said computational hardware processor.

4. The processor for real and quick payroll and tax documents of claim 1 where tax documents of tax withholding report contains at least name, social security number, address, income, social security, Medicare, tax status, deduction, exemption, retirement, child number, adjustable gross income, taxable income, tax rate, tax, credit, withholding tax, and payroll on national and local levels through said computational hardware processor.

5. The processor for real and quick payroll and tax documents of claim 1 where said tax return is done by said employee, payroll, withholding tax, and tax withholding report are done by said employer, and tax differences between said tax return and said tax withholding report are inspected by national or local government to reduce tax mistakes and fraud crimes.

6. The processor for real and quick payroll and tax documents of claim 1 where said payroll, withholding tax, tax withholding report, and tax return are done together or separately through said computational hardware processor.

7. The processor for real and quick payroll and tax documents of claim 1 where a web or network is designed for related applications.

8. The processor for real and quick payroll and tax documents of claim 1 where said tax documents of tax, withholding tax, tax withholding report, and tax return are based on the same linear and gradual tax rate procedures as a common format to process a plurality of taxation data.

9. A method for real and quick payroll and tax documents through a computational hardware processor comprising:
receiving, using said computational hardware processor, at least a filing period factor (F), tax status (S), income, deductions, and credits of an employee; using said filing period (F), tax status (S), income, deductions, exemptions, and credits to determine, via said computational hardware, an adjusted gross income and a taxable income (TI) of said employee;
using said filing period (F), tax status (S), income, deductions, exemptions, and credits to determine, via said computational hardware, an adjusted gross income and a taxable income (TI) of for said employee;
using said computational hardware processor to apply said taxable income with one of linear and gradual tax rate procedures with said tax status (S) and filing period (F) to determine a tax rate and a tax for said employee;
using said computational hardware processor to automatically select a taxable income range for said employee based on related taxable income and filing tax status, said taxable income range being selected from a group of taxable income ranges, consisting of two to five taxable income ranges;
using said computational hardware processor to apply said tax to determine a payroll payment for said employee;
transferring said payroll payment from an employer to said employee;
using said computational hardware processor to apply said tax to determine a tax document of withholding tax for said employee;
transferring said withholding tax from said employer to a government;
receiving, using said computational hardware processor, real income, tax status (S), deduction, and credit of said employee when real tax information is inputted or adjusted when real tax information is available;
using said computational hardware processor to apply said tax to determine a tax document of tax withholding report on yearly basis for said employee;
transferring said tax withholding report from said employer to said government and said employee;
using said computational hardware processor to apply said tax to determine a tax document of tax return on yearly basis report by said employee;
displaying said payroll payment on an output;
displaying said individual tax document of withholding tax on an output;
displaying said individual tax document of tax withholding report on an output;
displaying said individual tax document of tax return on an output;
wherein:
application of said linear procedure by said computational hardware processor includes a+TI*F/(b*S), where a and b are constants;
application of said gradual procedure by said computational hardware processor includes c−d*S/(TI*F), where c and d are constants;
application of said filing period factor (F) by said computational hardware processor is numbered with 52, 26, 24, 12, 4, 2 or 1 on weekly, bi-weekly, semi-monthly, monthly, quarterly, semi-annual or annual basis; and
application of said tax status (S) by said computational hardware processor is numbered at between 0.5 and 2.

10. The method for real and quick payroll and tax documents of claim 9 where said tax status is numbered at a range of 0.5-2 with a common number 1 for Married Filing Separately, 2 for Married Filing Jointly, 0.8-1.2 for Single, 1.3-1.8 for Head of Household or 1.5-2 for Qualifying Widow(er) through said computational hardware processor.

11. The method for real and quick payroll and tax documents of claim 9 where said linear and gradual tax rate system with a+TI*F/(b*S), c−d*S/(TI*F), where c and d are constants; filing period factor (F), taxable income (TI) and tax status (S) number, and 2-5 taxable income ranges/brackets are used.

12. The method for real and quick payroll and tax documents of claim 9 where tax differences between tax return and withholding report is inspected by a national or local government levels to reduce potential tax mistakes and fraud crimes.

13. A processor for real and quick business tax documents through a computational hardware processor comprising:
receiving, using said computational hardware processor, at least filing period factor (F), income, cost, deduction, and credit of a business;
using said filing period factor (F), income, cost, deduction, and credit to determine, via said computational hardware processor, for a taxable income (TI) of said business;
using said computational hardware processor to apply said taxable income with one of linear and gradual procedures with filing period factor (F) to determine a tax rate and a tax for said business;
using said computational hardware processor to apply said tax to determine a tax document of withholding tax for said business;
using said computational hardware processor to apply said tax to determine a tax document of tax withholding report for said business;
receiving, using said computational hardware processor, real income, cost, deduction, and credit of said business when real tax information is inputted or adjusted when real tax information is available;
using said computational hardware processor to apply said tax to determine a tax document of tax return for said business;
displaying said taxable income on an output;
displaying said tax document of withholding tax on an output;
displaying said tax document of tax withholding report on an output; and
displaying said tax document of tax return on an output.
wherein:
application of said linear procedure by said computational hardware processor includes a+TI*F/(b*S), where a and b are constants and S is a tax status;
application of said gradual procedure by said computational hardware processor includes c−d*S/(TI*F), where c and d are constants;
application of said filing period factor (F) by said computational hardware processor is numbered with 52, 26, 24, 12, 4, 2 or 1 on weekly, bi-weekly, semi-monthly, monthly, quarterly, semi-annual or annual basis; and
application of said tax status (S) by said computational hardware processor is numbered at between 0.5 and 3 with a common number 1.

14. The processor for real and quick business tax documents of claim 13 where monitor, keyboard, mouse, memory, data processor, storage, and output are involved in the processor.

15. The processor for real and quick business tax documents of claim 13 where the tax status is designed with number range of 0.5-2 for certain industry or service business categories with a common number 1.

16. The processor for real and quick business tax documents of claim 13 where said withholding tax, tax withholding report, and tax return are done by said employer, and tax differences between said tax return and said tax withholding report are inspected by national or local government to reduce tax mistakes and fraud crimes.

17. The processor for real and quick business tax document of claim 13 where said withholding tax, tax withholding report, and tax return are done together or separately through said computational hardware processor.

18. The processor for real and quick business tax document of claim 13 where a web or network is designed for related applications.

19. The processor for real and quick payroll and tax document of claim 13 where said tax documents of tax, withholding tax, tax withholding report, and tax return are used for business applications.
